(19) United States
(12) Patent Application Publication
(10) Pub. No.: US 2010/0196163 A1
(43) Pub. Date: Aug. 5, 2010

(54) METHOD OF MANUFACTURING IMPELLER, IMPELLER, AND COMPRESSOR HAVING IMPELLER

(76) Inventors: Nobuyori YAGI, Hiroshima-shi (JP); Eiichi Yanagisawa, Hiroshima-shi (JP); Yujiro Watanabe, Hiroshima-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/696,452

(22) Filed: Jan. 29, 2010

(30) Foreign Application Priority Data
Feb. 3, 2009 (JP) 2009-022867

(51) Int. Cl. F04D 29/34; B23P 15/04

(52) U.S. Cl. 416/214 R; 29/889

(57) ABSTRACT

A method of manufacturing an impeller including a substantially disk-shaped disk, a cover facing the disk, and a blade provided between the disk and the cover, the method includes: forming a groove in a blade attachment surface of the disk or the cover so as to correspond to the shape of an edge tip of the blade; and bonding an inner surface of the groove to the edge tip of the blade through a bonding agent after inserting the edge tip of the blade into the groove.

### BACKGROUND OF THE INVENTION

1. Field of the Invention

The present invention relates to a method of manufacturing an impeller used in a centrifugal rotary machine such as a centrifugal compressor, an impeller, and a compressor having the impeller.

Priority is claimed on Japanese Patent Application No. 2009-022867, filed Feb. 3, 2009, the content of which is incorporated herein by reference.

2. Description of the Related Art

In the past, as an impeller used in a centrifugal rotary machine such as a centrifugal compressor, there has been known a cover attachment impeller (closed impeller) including a disk attached to a rotary shaft, a cover disposed in the disk while having a gap therebetween, and plural blades connecting the disk and the cover to each other. In the impeller, a portion surrounded by a side surface of each blade and stream surfaces of the cover and the disk is formed as a passageway used to compress air. In addition, the impeller provided in the centrifugal compressor is formed by, for example, integral forming performed by casting, machining, or electric spark machining, or bonding performed by welding, brazing, or liquid phase diffusion bonding after forging and mechanical machining.

Among them, the integral forming is to integrally form the cover, the blade, and the disk by cutting a material. Incidentally, in general, the impeller provided in the centrifugal compressor includes a passageway formed in a complex shape in which the passageway is curved in the axial direction (rotary shaft direction) and the radial direction. For this reason, the integral forming is difficult.

In the bonding performed by welding, two parts, that is, an integral member obtained by integrally forming the blade with one of the cover and the disk through cutting and the other of the cover and the disk, are bonded to each other through welding. Alternatively, the blade, the cover, and the disk are bonded to each other through welding. In this case, it is necessary to insert a welding torch inside the passageway. Accordingly, when the passageway is narrow, it is difficult to insert the welding torch into the passageway. As a result, welding defects may easily occur.

Meanwhile, the bonding performed by brazing is known in, for example, JP-A-2003-328989 (hereinafter, Patent Document 1) or JP-A-H07-109997 (hereinafter, Patent Document 2). In the bonding performed by brazing, for example, upon bonding the blade attachment cover to the disk, filler metals such as foils, powders, or wires are disposed in the connection portion, and the cover and the disk are installed and heated in a furnace in a joining state so as to be bonded to each other. Even when the passageway is narrow, the bonding performed by brazing can be easily performed compared with the bonding performed by welding.

In the method of manufacturing the impeller disclosed in Patent Document 1, a plating layer is provided both in the combination of a blade and a shroud (cover) and in a hab (disk). The hab provided with a groove having an R-part in both sides thereof and the combination is bonded to each other. Alternatively, a plating layer is provided both in the combination of the blade and the hab and the shroud. The shroud provided with a groove having an R-part in both sides thereof and the combination is bonded to each other.

In the method of manufacturing the impeller disclosed in Patent Document 2, a main-plate-side blade integrally formed with a hab (disk) and a shroud-side blade integrally formed with a shroud (cover) are bonded to each other through filler metal.

However, the method of manufacturing the impeller of the related art has the following problems.

In the impeller provided in the centrifugal compressor, a tensile force is generated in a direction in which the cover and the disk move away from each other due to a centrifugal force with a rotation, and a relative bending stress is generated in the rotation direction. Accordingly, a large stress concentration is generated in a bonding portion corresponding to a joint between the blade and the disk. For this reason, in the case of the bonding performed by brazing, in order to reduce the stress concentration, it is necessary to consider a solution such that the brazing portion is formed in a fillet shape. However, as described above, each passageway R is formed in a complex curve shape, and the bonding line between the blade and either the disk or the cover is formed as a complex three-dimensional curve. Accordingly, the melted filler metal may flow outside during the brazing. That is, in this case, the amount of the filler metal may be not sufficient in a part of the bonding portion, or the filler metal may be lost, which may cause bonding defects. Accordingly, it is not possible to ensure sufficient bonding strength. For this reason, in the bonding performed by brazing, liquid phase diffusion bonding, or the like, there is a demand for a method capable of reliably improving the bonding strength.

The present invention is contrived in consideration of the above-described problem, and an object of the present invention is to provide a method of manufacturing an impeller capable of improving the bonding strength between a blade and either a disk or a cover, an impeller having a high bonding strength between a blade and either a disk or a cover, and a compressor having an impeller.

### SUMMARY OF THE INVENTION

In order to achieve the above-described object, according to an aspect of the present invention, there is provided a method of manufacturing an impeller including a substantially disk-shaped disk, a cover facing the disk, a blade provided between the disk and the cover, the method including: forming a groove in a blade attachment surface of the disk or the cover so as to correspond to the shape of an edge tip of the blade; and bonding an inner surface of the groove to the edge tip of the blade through a bonding agent after inserting the edge tip of the blade into the groove.

According to another aspect of the present invention, there is provided an impeller including: a substantially disk-shaped disk; a cover facing the disk; and a blade provided between the disk and the cover, wherein the blade is inserted into a groove formed in at least one of the disk and the cover, and is bonded thereto through use of a bonding agent.

With the above-described configuration, the groove is provided in the blade attachment surface of the disk or the cover so as to correspond to the shape of the edge tip of the blade, the bonding agent such as filler metal is disposed in the groove or the bonding-side edge tip of the blade, and then the edge tip of the blade is inserted into the groove by heating the bonding agent so as to bond to each other through use of a melted bonding agent. At this time, the bonding agent being in a liquid state due to heating is hardened inside the groove, and the edge tip of the blade is strongly fitted and bonded to the groove. In addition, since it is possible to prevent the melted bonding agent from flowing outside during the bonding operation, it is possible to prevent a problem such that the amount of the bonding material is not sufficient in the bonding portion.

The method having the above-described configuration may further include: disposing a bonding agent so as to bond a side surface of the blade to the blade attachment surface in the vicinity of the groove.

In this case, in addition to the bonding inside the groove, the side surface of the blade and the blade attachment surface are bonded to each other. Accordingly, it is possible to more reliably reinforce the bonding portion between the disk or the cover and the blade applied with large stress.

In the impeller having the above-described configuration, substantially semi-circular recessed portions each having a circular-arc surface in a sectional view may be provided on both sides of the groove along the groove.

In this case, it is possible to alleviate the stress concentration generated in the bonding portion between the blade and either the cover or the disk during the rotation of the impeller. Particularly, since the edge tip of the groove is close to the side surface of the blade so as to be smoothly continuous thereto, it is possible to increase the advantage of reducing the stress concentration.

In the method of manufacturing the impeller and in an impeller having the above-described configuration, the bonding agent melted by heating is disposed inside the groove provided in the disk or the cover, and the bonding agent being in a liquid state by heating is hardened inside the groove so that the edge tip of the blade is tightly fitted and bonded to the groove. Accordingly, it is possible to reliably improve the bonding strength between the blade and either the cover or the disk.

The compressor according to still another aspect of the present invention includes an impeller having a high bonding strength between the blade and the disk or the cover manufactured by the method of manufacturing the impeller according to an aspect of the present invention.

### BRIEF DESCRIPTION OF THE DRAWINGS

FIG. 1 is a side sectional view showing a schematic configuration of an impeller manufactured by a method of manufacturing an impeller according to a first embodiment of the present invention.

FIG. 2 is a partially enlarged view showing an impeller in FIG. 1.

FIG. 3 is a schematic side view showing the impeller in FIG. 2 when seen from the outer peripheral side thereof.

FIG. 4A is a view showing a state before brazing in an impeller manufacturing process.

FIG. 4B is a view showing a state after the brazing in the impeller manufacturing process.

FIG. 5 is a schematic side view showing the impeller according to a first modified example of the first embodiment of the present invention when seen from the outer peripheral side thereof.

FIG. 6 is a schematic side view showing the impeller according to a second modified example of the first embodiment of the present invention when seen from the outer peripheral side thereof.

FIG. 7 is a schematic side view showing the impeller according to a third modified example of the first embodiment of the present invention when seen from the outer peripheral side thereof.

FIG. 8 is a schematic side view showing the impeller according to a fourth modified example of the first embodiment of the present invention when seen from the outer peripheral side thereof.

FIG. 9 is a schematic side view showing the impeller according to a second embodiment of the present invention when seen from the outer peripheral side thereof.

FIG. 10 is a schematic side view showing the impeller according to a modified example of the second embodiment when seen from the outer peripheral side thereof.

### DETAILED DESCRIPTION OF THE INVENTION

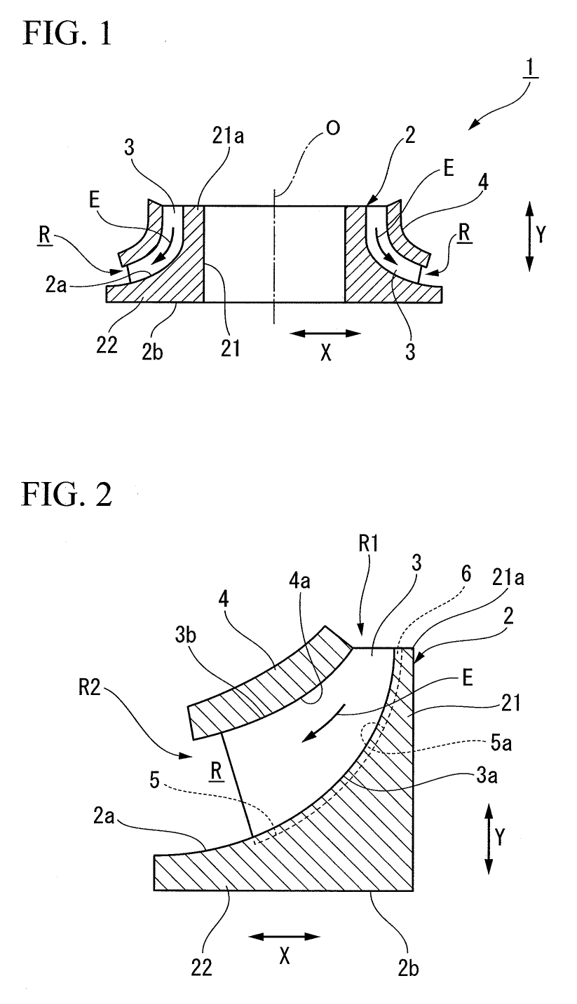

Hereinafter, a method of manufacturing an impeller and an impeller according to a first embodiment of the present invention will be described with reference to FIGS. 1 to 4A and 4B.

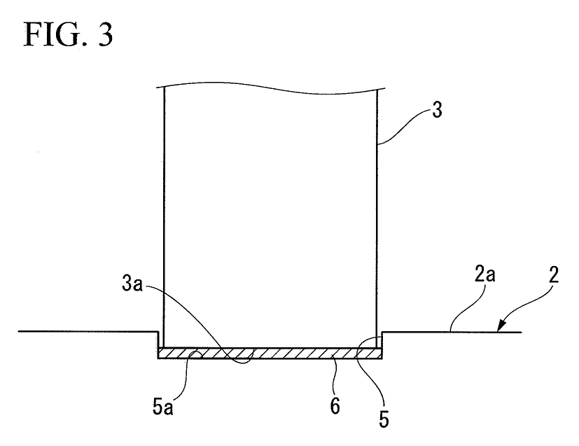

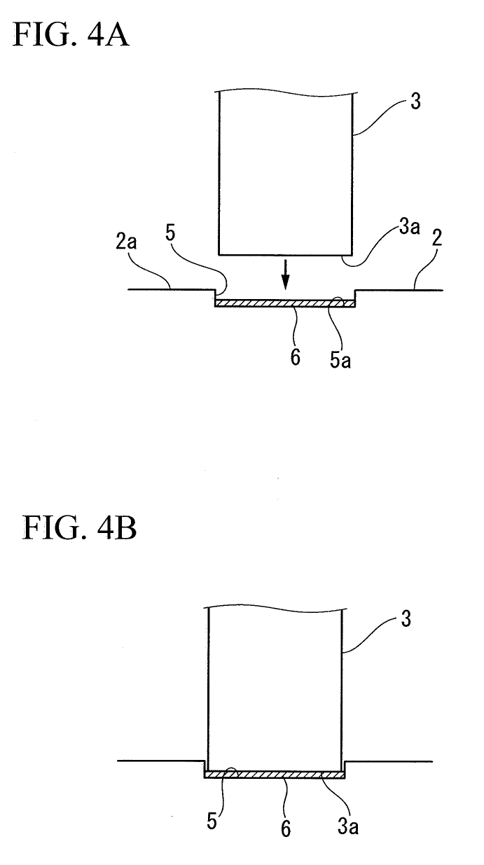

FIG. 1 is a side sectional view showing a schematic configuration of an impeller manufactured by a method of manufacturing an impeller according to a first embodiment of the present invention. FIG. 2 is a partially enlarged view showing an impeller in FIG. 1. FIG. 3 is a schematic side view showing the impeller in FIG. 2 when seen from the outer peripheral side thereof. FIG. 4A is a view showing a state before brazing in an impeller manufacturing process. FIG. 4B is a view showing a state after the brazing in the impeller manufacturing process.

The reference numeral 1 in FIG. 1 indicates an impeller manufactured by the method of manufacturing the impeller according to the first embodiment. The impeller is a rotary body which is assembled to a rotary shaft, and is mounted to a compressor such as a centrifugal compressor.

As shown in FIGS. 1 and 2, the impeller 1 includes a substantially disk-shaped disk 2 which is coaxially attached to a rotary shaft (not shown), plural vane-shaped blades 3, each of which has one end fixed onto the disk 2 and which are radially disposed about the axis O of the rotary shaft, and a cover 4 which is disposed to face the disk 2 while being distant therefrom and is fixed to the other end of each blade 3. In addition, a space formed between a side surface of the blade 3 and a stream surface (surfaces facing each other) between the disk 2 and the cover 4 serves as a passageway R of a gas used to compress the compressor.

The right side on FIG. 2 is set to the inner peripheral side (the side of the axis O shown in FIG. 1) of the impeller 1, and the left side is set to the outer peripheral side. In FIGS. 1 and 2, in a gas flowing direction (a direction indicated by the arrow E) inside the passageway R, the upper side is set to the upstream side, and the lower side is set to the downstream side. The rotary shaft direction of the impeller 1 is set to the Y direction, and the radial direction thereof is set to the X direction. Hereinafter, the directions will be consistently used.

The disk 2 is used to form the outer shape of the impeller 1, and is formed of metal such as carbon steel or stainless steel. The disk 2 includes a cylindrical portion 21 into which the rotary shaft (not shown) is fitted and a body portion 22 which extends from one end (that is, the lower side on FIGS. 1 and 2) of the cylindrical portion 21 in the rotary shaft direction Y toward the outer peripheral side in the radial direction X, where the cylindrical portion 21 and the body portion 22 are integrally formed with each other. Here, it will be described hereinafter on the assumption that the upper surface (on the side of the passageway R of the gas), facing the cover 4, of the disk 2 shown in FIGS. 1 and 2 is set to a front surface 2a, and the opposite lower surface thereof is set to a rear surface 2b. The front surface 2a of the body portion 22 is formed in a curve shape which gradually protrudes toward a front end 21a of the cylindrical portion 21 in the rotary shaft direction Y in a direction from the outer peripheral side to the inner peripheral side.

As shown in FIGS. 2 and 3, the front surface 2a of the disk 2 is provided with a groove 5 which corresponds to an edge tip 3a of the blade 3 on the side of the disk 2, and has a thickness slightly larger than that of the blade 3. In addition, in this embodiment, filler metal 6 (bonding agent) such as powder or wire is disposed on a bottom portion 5a (groove inner surface) of the groove 5 so as to bond the blade 3 to the disk 2 by brazing. In addition, the depth of the groove 5 is, for example, equal to or more than 1 mm and equal to or less than 2 mm. In the case where the depth of the groove 5 becomes deeper, the amount of the filler metal 6 increases. For this reason, it is desirable that the depth of the groove 5 is shallow.

Each blade 3 provided between the disk 2 and the cover 4 is smoothly curved so as to protrude toward the front end in the rotary shaft direction (the direction indicated by the arrow Y) as it becomes closer to the inner peripheral side in the radial direction (the direction indicated by the arrow X) along the front surface 2a of the disk 2, and is curved toward one side of the disk 2 in the circumferential direction.

A lower surface 4a of the cover 4 is integrally fixed to a cover-side bonding end 3b of the blade 3, and the cover 4 is formed in a curve shape which protrudes toward the front end in the rotary shaft direction Y in a direction from the outer peripheral side to the inner peripheral side in the radial direction (the direction indicated by the arrow X).

That is, as described above, the passageway R is formed between the adjacent blades 3 so as to generate compressed air with the rotation of the impeller 1. The passageway R is formed in a curve shape in the rotary shaft direction Y and the circumferential direction along the shapes of the disk 2, the blade 3, and the cover 4.

In the case where the impeller 1 of the compressor having the above-described configuration is rotationally driven about the axis O by a driving unit (not shown), the air stream is generated, and the air is accelerated by the centrifugal force generated by the rotation, where the air stream is indicated by the arrow E facing from the inner peripheral side to the outer peripheral side in the radial direction in the passageway R. Accordingly, the air sucked into an inlet R1 of the passageway R is compressed inside the passageway R and is discharged from an outlet R2. Subsequently, the air is sent to an external device (not shown) on the downstream side.

Next, the method of manufacturing the impeller 1 will be described. First, as shown in FIG. 4A, the groove 5 is formed in a blade attachment surface (front surface 2a) of the disk 2 so as to correspond to the shape of the blade 3, and as shown in FIG. 2, the cover 4 is integrally formed with the plural blades 3 by cutting a material.

Subsequently, the filler metal 6 is disposed throughout the bottom portion 5a of the groove 5, and as shown in FIG. 4B, the edge tip 3a of the blade 3 is inserted into the groove 5 so that the inner surface of the groove 5 is bonded to the edge tip 3a of the blade 3 through the filler metal 6. In detail, when the filler metal 6 interposed between the blade 3 and the groove 5 of the disk 2 is heated while applying, for example, a compressing force thereto, the filler metal 6 is melted, and the liquid-state filler metal 6 is uniformly distributed throughout the gap between the groove 5 and the blade 3, thereby bonding the disk 2 to the blade 3. That is, since the groove 5 is provided, the filler metal 6 being in a liquid state by heating is hardened inside the groove 5, and the edge tip 3a of the blade 3 is fitted to the groove 5. Accordingly, it is possible to strongly bond them to each other. Further, since the melted filler metal 6 does not flow outside from the groove 5 during the bonding operation, it is possible to prevent a problem of the amount of the filler metal 6 not being sufficient due to the outflow of the filler metal 6.

In the method of manufacturing the impeller and the compressor according to the first embodiment, since the filler metal 6 melted by heating is disposed inside the groove 5 provided in the disk 2, the filler metal 6 being in a liquid state by heating is hardened inside the groove 5, and the edge tip 3a of the blade 3 is tightly fitted and bonded to the groove 5. Accordingly, it is possible to reliably improve the bonding strength between the disk 2 and the blade 3.

Next, another embodiment and modified examples will be described with reference to the accompanying drawings. Since the same reference numerals will be given to the same constituents as those of the first embodiment, the description thereof will be omitted, and a configuration different from that of the first embodiment will be described.

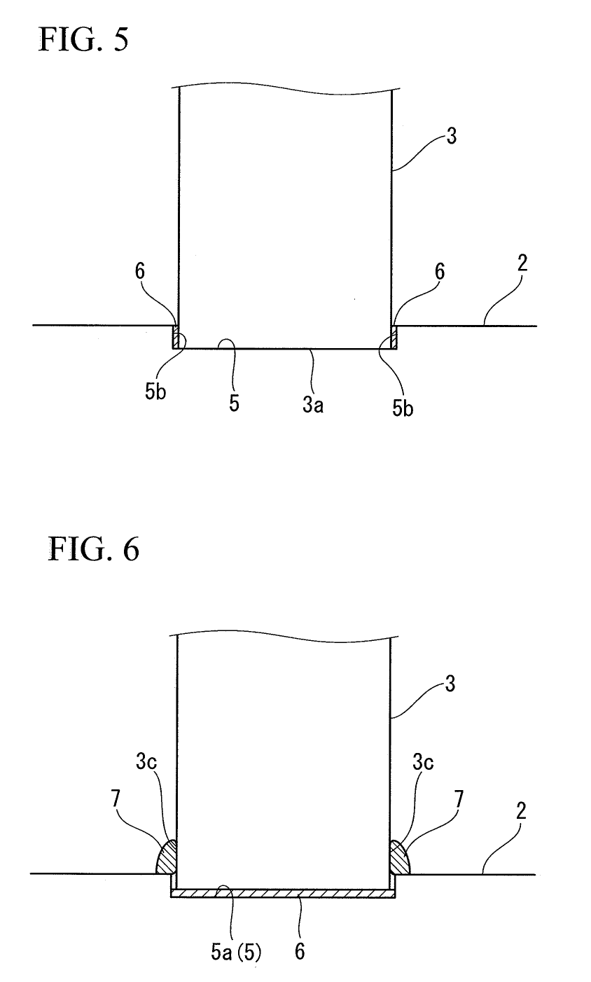

FIG. 5 is a schematic side view showing the impeller according to a first modified example of the first embodiment of the present invention when seen from the outer peripheral side thereof.

As shown in FIG. 5, the filler metal 6 is disposed in the bottom portion 5a (see FIG. 3) of the groove 5 in the first embodiment, but in the first modified example, instead of that position, the filler metals 6 are respectively disposed in both side surfaces (groove inner surfaces) 5b and 5b of the groove 5 formed in the disk 2. Even in this case, as in the first embodiment, the groove 5 is formed in the disk 2 in advance, and the edge tip 3a of the blade 3 integrally formed with the cover 4 (see FIG. 2) is inserted into the groove 5, thereby bonding the disk 2 to the blade 3 through the filler metals 6.

FIG. 6 is a schematic side view showing the impeller according to a second modified example of the first embodiment of the present invention when seen from the outer peripheral side thereof.

As shown in FIG. 6, in the second modified example, in the state where the blade 3 is inserted into the groove 5 having the filler metal 6a disposed in the bottom portion 5a, filler metals (bonding agents) 7 are respectively disposed in even attachment corner portions 3c corresponding to the base portion of the blade 3 on the side of the disk 2. That is, in addition to the bonding inside the groove 5, the front surface 2a of the disk 2 forming the blade attachment surface in the vicinity of the groove 5 is bonded to the side surfaces of the blade 3 through the filler metals 7, thereby more reliably reinforcing the bonding portion between the blade 3 and the disk 2 applied with the largest stress during the rotation of the impeller.

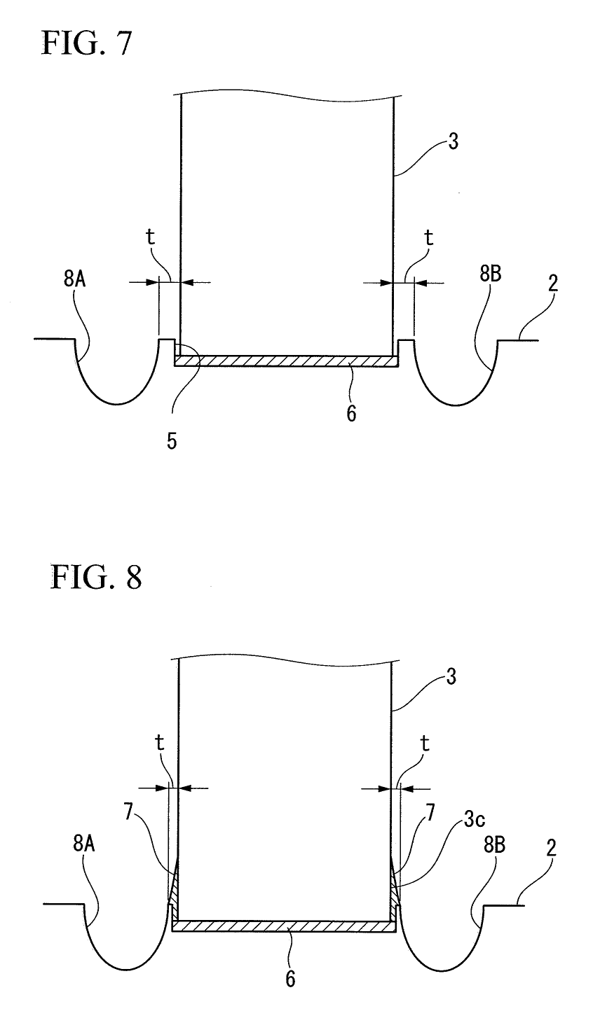

FIG. 7 is a schematic side view showing the impeller according to a third modified example of the first embodiment of the present invention when seen from the outer peripheral side thereof. FIG. 8 is a schematic side view showing the impeller according to a fourth modified example of the first embodiment of the present invention when seen from the outer peripheral side thereof.

In the third modified example shown in FIG. 7, substantially semi-circular R grooves (recessed portions) 8A and 8B each having a circular-arc surface in a sectional view are provided on both sides of the groove 5 of the disk 2 along the groove 5. Since the R grooves 8A and 8B are provided, it is possible to exhibit a function of alleviating stress concentration caused by the blade 3 during the rotation of the impeller. The diameter or depth of each circular-arc surface of the R grooves 8A and 8B is determined in accordance with the thickness of the disk 2. In addition, it is desirable that the advantage of the stress alleviation function becomes larger as the distance t between each of the R grooves 8A and 8B and the side surface of the blade 3 fitted to the groove 5 becomes smaller.

That is, as in the fourth modified example in FIG. 8, when the distance t becomes minimal, the reinforcing filler metals 7 respectively disposed on the attachment corner portions 3c of the blade 3 with respect to the disk 2 are smoothly and continuously distributed in the edge tips of the circumferential surfaces of the R grooves 8A and 8B, and the connection surface is formed as a continuous curve surface. Accordingly, it is possible to increase the advantage of reducing the stress concentration generated in the bonding portion during the rotation of the impeller.

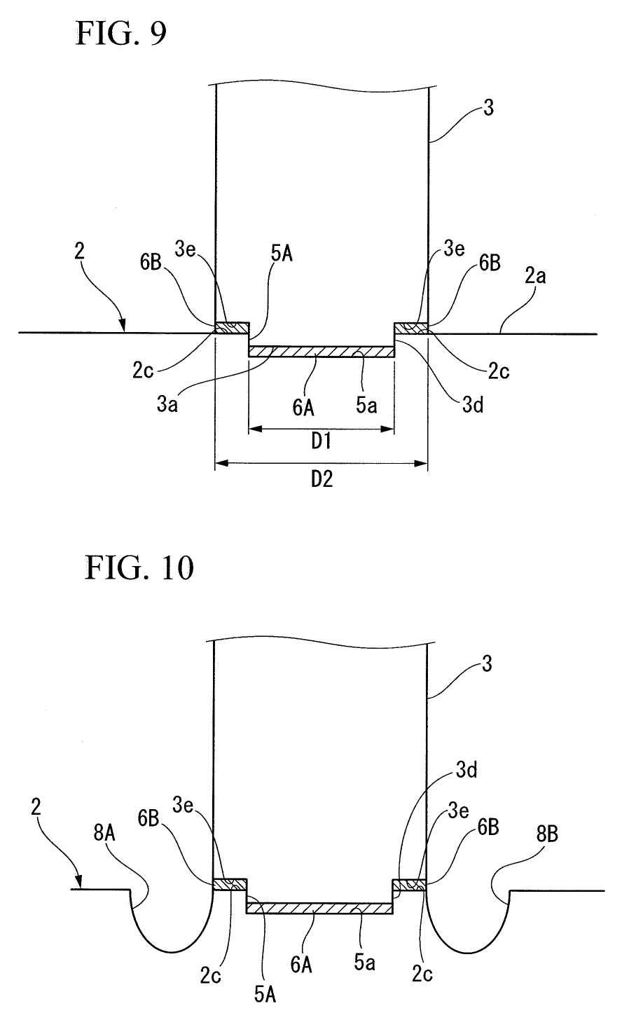

FIG. 9 is a schematic side view showing the impeller according to a second embodiment of the present invention when seen from the outer peripheral side thereof.

In the second embodiment shown in FIG. 9, the width D1 of a groove 5A formed in the disk 2 is set to be smaller than the width D2 of the blade 3, and a protruding portion 3d is formed in the disk edge tip 3a of the blade 3 so as to be fittable to the corresponding groove 5A. In addition, filler metals indicated by the reference numeral 6A is disposed in the bottom portion 5a of the groove 5A, and filler metals indicated by the reference numeral 6B are respectively disposed in groove edges 2c of the front surface 2a of the disk 2 located on both sides of the groove 5A. That is, the groove edges 2c of the disk 2 are respectively bonded to stepped surfaces 3e formed by the protruding portions 3d of the blade 3 through the filler metals 6B.

FIG. 10 is a schematic side view showing the impeller according to a modified example of the second embodiment when seen from the outer peripheral side thereof.

In the modified example (fifth modified example) of the second embodiment shown in FIG. 10, the R grooves 8A and 8B according to the third and fourth modified examples are provided in the structure according to the second embodiment. The edge tips of the circular-arc surfaces of the R grooves 8A and 8B on the side of the blade 3 are respectively smoothly continuous to the side surfaces of the blade 3. Accordingly, it is possible to more effectively alleviate the stress concentration generated in the bonding portion between the disk 2 and the blade 3.

As described above, although the method of manufacturing the impeller and the impeller according to the first and second embodiments and the first to fifth modified examples of the present invention are described, the present invention is not limited to the above-described embodiments and modified examples, but may be appropriately modified within the scope without departing from the spirit of the present invention.

For example, in the above-described embodiments and modified examples, the blade attachment surface as the front surface 2a of the disk 2 is provided with the groove 5, but the present invention is not limited thereto. For example, the disk 2 and the blade 3 may be integrally formed in advance, the groove may be formed in the blade attachment surface of the cover 4 so as to correspond to the blade, and then the blade 3 integrally formed with the disk 2 may be inserted and bonded to the groove through the filler metal 6.

In the above-described embodiments and modified examples, the bonding operation is performed by the brazing, but the present invention is not limited thereto. For example, liquid phase diffusion bonding may be used.

In the above-described embodiments and modified examples, the bonding method is used which disposes the filler metal 6 in the groove inner surface (the bottom portion 5a and the side surface 5b) on the side of the disk 2, and inserts and bonds the edge tip 3a of the blade to the groove 5, but the present invention is not limited thereto. That is, in the state where the filler metal 6 is disposed in the edge tip 3a of the blade without disposing the filler metal 6 in the groove 5, the edge tip 3a of the blade may be inserted and bonded to the groove 5.

In addition, the shapes, sizes, and the like of the disk 2, the blade 3, and the cover 4 may be arbitrarily set. Further, the depth and width of the groove 5, the dimension of the R grooves 8A and 8B, and the like may be arbitrarily set depending on the conditions.

While preferred embodiments of the present invention have been described and illustrated above, it should be understood that these are exemplary of the present invention and are not to be considered as limiting. Additions, omissions, substitutions, and other modifications can be made without departing from the spirit or scope of the present invention. Accordingly, the present invention is not to be considered as being limited by the foregoing description, and is only limited by the scope of the appended claims.

1. A method of manufacturing an impeller including a substantially disk-shaped disk, a cover facing the disk, and a blade provided between the disk and the cover, the method comprising:
forming a groove in a blade attachment surface of the disk or the cover so as to correspond to the shape of an edge tip of the blade; and
bonding an inner surface of the groove to the edge tip of the blade through a bonding agent after inserting the edge tip of the blade into the groove.

2. The method according to claim 1, further comprising:
disposing a bonding agent so as to bond a side surface of the blade to the blade attachment surface in the vicinity of the groove.

3. An impeller comprising:
a substantially disk-shaped disk;
a cover facing the disk; and
a blade provided between the disk and the cover,
wherein the blade is inserted into a groove formed in at least one of the disk and the cover, and is bonded thereto through use of a bonding agent.

4. The impeller according to claim 3,
wherein substantially semi-circular recessed portions each having a circular-arc surface in a sectional view are provided on both sides of the groove along the groove.

5. A compressor comprising the impeller according to claim 3 4.

6. A compressor comprising the impeller according to claim 4.
